(19) United States
(12) Patent Application Publication
(10) Pub. No.: US 2018/0098340 A1
(43) Pub. Date: Apr. 5, 2018

(54) BASE STATION, WIRELESS TERMINAL, AND CONTROL METHOD OF BASE STATION

(71) Applicant: NEC CORPORATION, Tokyo (JP)

(72) Inventor: Toshiyuki SASHIHARA, Tokyo (JP)

(73) Assignee: NEC CORPORATION, Tokyo (JP)

(21) Appl. No.: 15/720,545

(22) Filed: Sep. 29, 2017

(30) Foreign Application Priority Data
Sep. 30, 2016 (JP) 2016-193377

(51) Int. Cl. H04W 72/12; H04W 72/04

(52) U.S. Cl. CPC H04W 72/1278; H04W 88/02; H04W 72/0453; H04W 72/042

(57) ABSTRACT

A base station configured to perform wireless communication with a wireless terminal includes a storage device and a processor. The storage device is configured to store a scheduling policy associated with an identifier of the wireless terminal, and indicating that at least one of a first frequency band and a second frequency band is used for the wireless communication. The processor is configured to determine a first scheduling policy associated with a first identifier of a first wireless terminal, based on the storage device when implementation of carrier aggregation relating to the first frequency band and the second frequency band is determined, and to allocate wireless resources to the first wireless terminal, based on the first scheduling policy.

This application is based upon and claims the benefit of priority from Japanese Patent Application No. 2016-193377, filed on Sep. 30, 2016, the disclosure of which is incorporated herein in its entirety by reference.

### TECHNICAL FIELD

The present disclosure relates to a base station, a wireless terminal, a server, and a control method of a base station.

### BACKGROUND ART

NPL 1 describes Licensed-Assisted Access (LAA). LAA is a system for transmitting downlink user data with use of an unlicensed band. An unlicensed band is also used in a wireless communication technique (e.g. WiFi (Registered trademark)) other than Long-Term Evolution (LTE).

A cell of an LAA system utilizes carrier aggregation, and is used together with a cell of an LTE system which uses a licensed license band.

### CITATION LIST

### Non Patent Literature

[NPL 1] TS36.300 (3GPP TS 36.300 V13.3.0 (2016-03), Evolved Universal Terrestrial Radio Access (E-UTRA) and Evolved Universal Terrestrial Radio Access Network (E-UTRAN); Overall description; Stage 2)

### SUMMARY

However, NPL 1 does not describe that only a cell of an LAA system is used alone in carrier aggregation.

Further, the inventor has found that there is a case that a scheduler of a base station does not take into account allocation of wireless resources requested by a wireless terminal. For instance, there is a case that allocation of wireless resources such that traffic is distributed only to an unlicensed band is not performed. This is because information associated with an identifier of a wireless terminal and indicating which frequency band is to be used is not taken into account when wireless resources of a base station are allocated.

In view of the above, one of the objects of exemplary example embodiments is to provide a novel configuration for allocating wireless resources relating to frequency bands different from each other. Note that this object is merely one of a plurality of objects to be achieved by example embodiments disclosed in the present description. Other objects or tasks, and novel features are clarified from description of the present description or from the accompanying drawings.

### Solution to Problem

A base station configured to perform wireless communication with a wireless terminal in an exemplary example embodiment comprises a storage device and a processor. The storage device is configured to store a scheduling policy associated with an identifier of the wireless terminal, and indicating that at least one of a first frequency band and a second frequency band is used for the wireless communication. The processor is configured to determine a first scheduling policy associated with a first identifier of a first wireless terminal, based on the storage device when implementation of carrier aggregation relating to the first frequency band and the second frequency band is determined, and to allocate wireless resources to the first wireless terminal, based on the first scheduling policy.

A wireless terminal configured to perform wireless communication with a base station in another exemplary example embodiment comprises a transmitter and a receiver. The transmitter is configured to transmit, to the base station, a message including a scheduling policy associated with an identifier of a wireless terminal, and indicating that at least one of a first frequency band and a second frequency band is used for the wireless communication. The receiver is configured to receive allocation of wireless resources to be performed based on the scheduling policy after implementation of carrier aggregation relating to the first frequency band and the second frequency band is determined.

A server in another exemplary example embodiment comprises a storage device and a network interface. The storage device is configured to store a scheduling policy associated with an identifier of a wireless terminal, and indicating that at least one of a first frequency band and a second frequency band is used for wireless communication between the wireless terminal and a base station. The network interface is configured to transmit the scheduling policy to a core network device included in a core network when the network interface receives the identifier of the wireless terminal from the core network device. Wireless resources are allocated to the wireless terminal based on the scheduling policy after implementation of carrier aggregation relating to the first frequency band and the second frequency band is determined.

A control method of a base station configured to perform wireless communication with a wireless terminal in another exemplary example embodiment comprises: storing a scheduling policy associated with an identifier of the wireless terminal, and indicating that at least one of a first frequency band and a second frequency band is used for the wireless communication; determining a first scheduling policy associated with a first identifier of a first wireless terminal out of the stored scheduling policy when implementation of carrier aggregation relating to the first frequency band and the second frequency band is determined; and allocating wireless resources to the first wireless terminal, based on the first scheduling policy.

### Advantageous Effects of Invention

According to the exemplary example embodiments, it is possible to provide a novel configuration for allocating wireless resources relating to frequency bands different from each other.

### BRIEF DESCRIPTION OF THE DRAWINGS

FIG. 1 illustrates a mobile communication system in a first exemplary example embodiment.

FIG. 2 illustrates a base station in the first exemplary example embodiment.

FIG. 3 illustrates an example of a scheduling policy in the first exemplary example embodiment.

FIG. 4 illustrates an operation in the first exemplary example embodiment.

FIG. 5 illustrates another example of a scheduling policy in the first exemplary example embodiment.

FIG. 6 illustrates an operation in the first exemplary example embodiment.

FIG. 7 illustrates a mobile communication system in a second exemplary example embodiment.

FIG. 8 illustrates an example of a scheduling policy in the second exemplary example embodiment.

FIG. 9 illustrates another example of a scheduling policy in the second exemplary example embodiment.

FIG. 10 illustrates an operation in the second exemplary example embodiment.

FIG. 11 illustrates an operation in the second exemplary example embodiment.

FIG. 12 illustrates a base station in a third exemplary example embodiment.

FIG. 13 illustrates a wireless terminal in the third exemplary example embodiment.

FIG. 14 illustrates a server in the third exemplary example embodiment.

### EXAMPLE EMBODIMENT

Details of exemplary example embodiments are described with reference to the drawings. In each of the drawings, same reference numerals are appended to identical or associated elements, and redundant description thereof is omitted as necessary to clarify the description.

A plurality of exemplary example embodiments described in the following may be implemented independently, or may be implemented in combination appropriately.

### 1. First Exemplary Example Embodiment

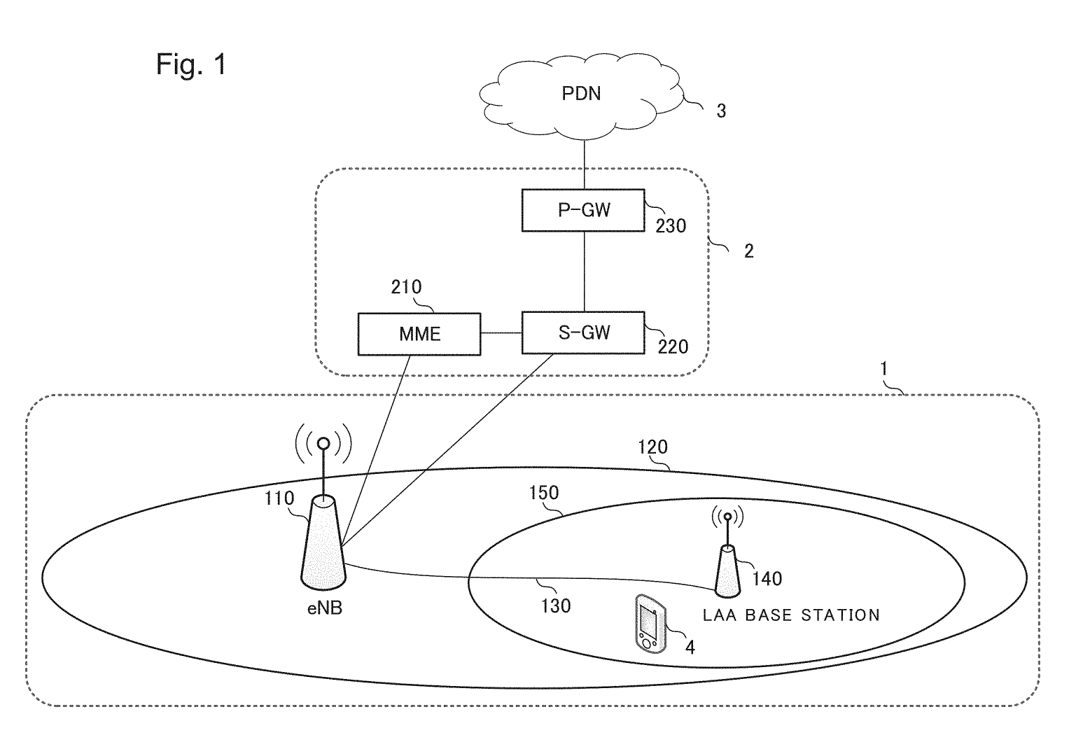

FIG. 1 illustrates a mobile communication system in a first exemplary example embodiment.

In FIG. 1, the mobile communication system includes an Evolved Universal Terrestrial Access Network (E-UTRAN) 1, an Evolved Packet Core (EPC) 2, a Packet Data Network (PDN) 3, and a User Equipment (UE, also referred to as a wireless terminal) 4.

The E-UTRAN 1 includes an eNB 110 and an LAA base station 140.

The eNB 110 provides the wireless terminal 4 with an information communication service with use of a licensed frequency band.

An LTE cell 120 is a coverage area to be covered by the eNB 110.

The LAA base station 140 is provided in the LTE cell 120 (a coverage area) of the eNB 110. The LAA base station 140 provides the wireless terminal 4 with an information communication service with use of an unlicensed frequency together with the eNB 110 which uses a licensed frequency when carrier aggregation is implemented.

An LAA cell 150 is a coverage area to be covered by the LAA base station 140.

The eNB 110 and the LAA base station 140 are connected by an inter-base station interface 130. A communication medium such as an optical cable is used in the inter-base station interface 130, for instance. For instance, a general purpose interface such as an Open Base Station Architecture Initiative (OBSAI) or a Common Public Radio Interface (CPRI) may be used as the inter-base station interface 130.

Note that it is also possible to use the eNB 110 as control and a base band unit (BBU), and to use the LAA base station 140 as a wireless unit (RRH: Remote Radio Head).

The wireless terminal 4 is configured to be communicable with at least one of the eNB 110 and the LAA base station 140.

The EPC 2 includes a Mobility Management Entity (MME) 210, a Serving Gateway (S-GW) 220, and a PDN Gateway (P-GW) 230.

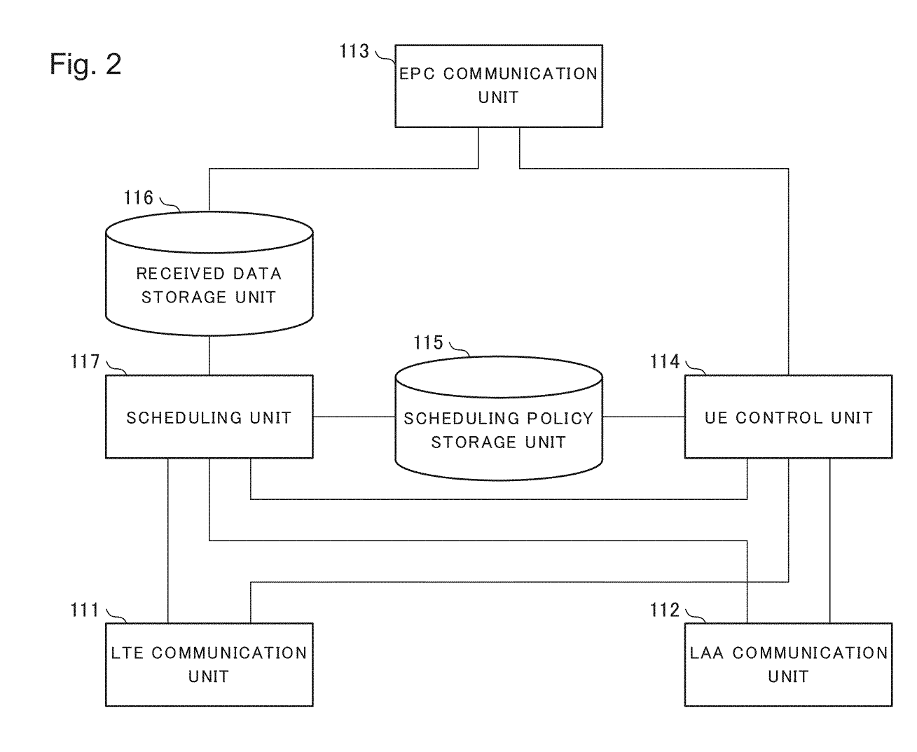

FIG. 2 illustrates a base station in the first exemplary example embodiment.

In FIG. 2, the eNB 110 includes an LTE communication unit 111, an LAA communication unit 112, an EPC communication unit 113, a UE control unit 114, a scheduling policy storage unit 115, a received data storage unit 116, and a scheduling unit 117.

The LTE communication unit 111 transmits user data received from the scheduling unit 117 with use of a licensed frequency to the wireless terminal 4 (UE). The LTE communication unit 111 receives user data from the wireless terminal 4 with use of a licensed frequency. The LTE communication unit 111 transmits and receives a control signal necessary for controlling the UE by the UE control unit 114.

The LAA communication unit 112 transmits user data received from the scheduling unit 117 with use of an unlicensed frequency via the LAA base station 140. The LAA communication unit 112 can receive user data from the wireless terminal 4 with use of an unlicensed frequency. Further, the LAA communication unit 112 transmits and receives a control signal necessary for controlling the UE by the UE control unit 114 with use of an unlicensed frequency.

The EPC communication unit 113 transmits and receives a control signal and user data to and from the EPC 2. The EPC communication unit 113 may function as a network interface configured to receive a scheduling policy to be described later from a core network device.

The UE control unit 114 receives a control signal from the LTE communication unit 111 and from the LAA communication unit 112, and controls the wireless terminal 4. For instance, in a case where the wireless terminal 4 performs an attach operation to the eNB 110, the UE control unit 114 transmits and receives a control signal relating to the attach operation. For instance, the UE control unit 114 saves (stores), in the scheduling policy storage unit 115, information relating to a scheduling policy of the UE, which is obtained by the aforementioned processes. For instance, the UE control unit 114 receives a scheduling policy from the wireless terminal 4 (UE) or from an HSS (Home Subscriber Server). The UE control unit 114 stores a received scheduling policy in the scheduling policy storage unit 115 together with an identifier (a UE identifier) for identifying the wireless terminal 4. Note that, the UE control unit 114 may be simply referred to as a communicator, for instance. Further, at least one of the LTE communication unit 111 and the LAA communication unit 112, and the UE control unit 114 may be referred to as a communicator.

The scheduling policy storage unit 115 stores scheduling policy information of the UE received from the UE control unit 114.

The scheduling unit 117 receives, from the UE control unit 114, a notification that communication is performed (started) with use of the LAA communication unit 112 regarding a certain UE. The scheduling unit 117 that receives the notification receives (acquires) a scheduling policy from the scheduling policy storage unit 115, and performs scheduling based on the policy with respect to the UE. Herein, a scheduling policy represents how data received by the EPC communication unit 113 regarding the UE is allocated to wireless resources for at least either one of the LTE communication unit 111 and the LAA communication unit 112. Wireless resources (communication resources) are allocated to the LTE communication unit 111 or the LAA communication unit 112, or to both of the communication units according to a scheduling policy associated with the UE.

When measurement information (e.g. a measurement result on a wireless quality) measured in the wireless terminal 4 is received from at least either one of the LTE communication unit 111 and the LAA communication unit 112, the UE control unit 114 confirms whether or not the wireless terminal 4 is present within coverages of the eNB 110 and the LAA base station 140. The UE control unit 114 determines whether or not the LAA base station 140 transmits data to the wireless terminal 4 together with the eNB 110, based on a confirmation result (determination of carrier aggregation). The result is notified to the scheduling unit 117 together with a UE identifier.

Note that measurement information is a measurement report, for instance. A measurement report may be transmitted at a timing triggered by a predetermined reporting event. Further, in a case where a periodic report is set, a measurement report may be transmitted at a timing when a timer of the periodic report expires.

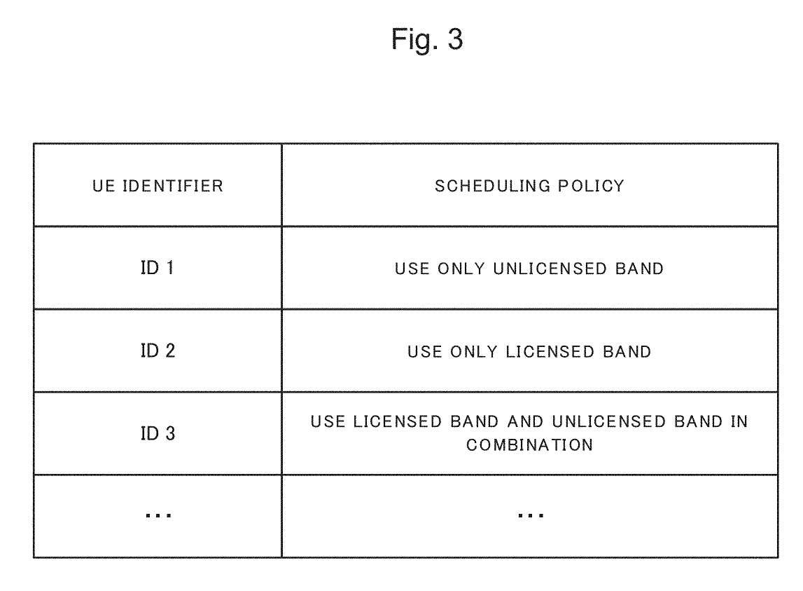

FIG. 3 illustrates an example of a scheduling policy in the first exemplary example embodiment. In FIG. 3, a scheduling policy is stored as a table constituted by two columns i.e. a UE identifier column and a scheduling policy column. An identifier for uniquely identifying a UE in an eNB, such as a Cell Radio Network Temporary Identifier (C-RNTI), is stored in a UE identifier column.

A scheduling policy to be applied in a case where both of communication means i.e. the LTE communication unit 111 and the LAA communication unit 112 are usable with respect to a UE (wireless terminal 4) to be stored in a UE identifier column is stored in a scheduling policy column.

For instance, scheduling policies such as “using only an unlicensed band”, “using only a licensed band”, and “using both of a licensed band and an unlicensed band” are stored.

The received data storage unit 116 is a means for temporarily storing data addressed to the wireless terminal 4, which is received from the EPC communication unit 113 (e.g. a buffer for buffering data).

The scheduling unit 117 performs scheduling of wireless resources. The scheduling is for transmitting received data addressed to a UE, which is stored in the received data storage unit 116, to the UE according to a scheduling policy to be applied to the UE in the scheduling policy storage unit 115.

Note that wireless resources indicate at least one of a resource block, a modulation scheme, and a coding rate, for instance. Scheduling indicates that these wireless resources are allocated to a certain UE at each predetermined period (TTI: Trans-mission Time Interval). A UE can know allocated wireless resources by monitoring a channel (PDCCH: Physical downlink Control Channel) on which these allocations are notified.

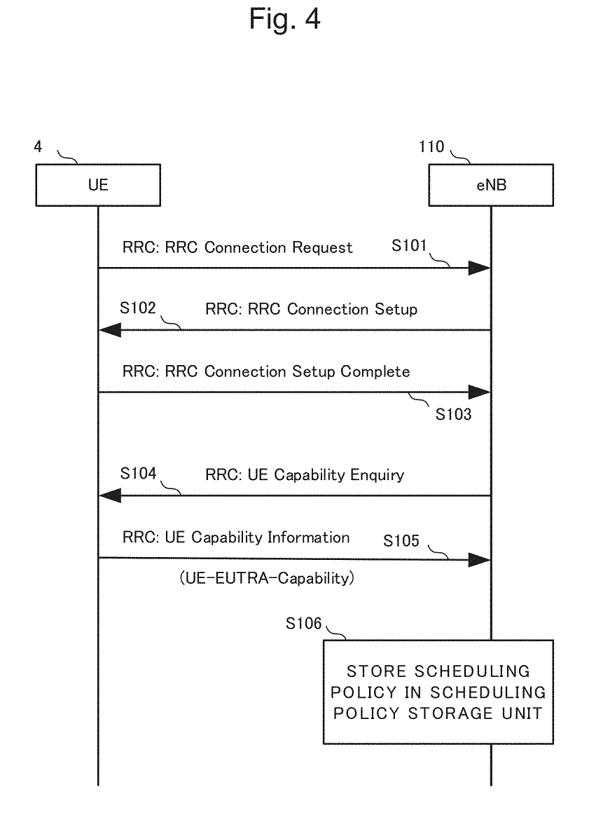

FIG. 4 illustrates an operation in the first exemplary example embodiment.

FIG. 4 illustrates an operation in a case where a scheduling policy of the wireless terminal 4 is stored in the scheduling policy storage unit 115.

When the wireless terminal 4 is attached to the eNB 110 for the first time, message exchange for establishing RRC connection is performed.

In S101, the wireless terminal 4 transmits an RRC: RRC CONNECTION REQUEST message to the eNB 110.

In S102, the eNB 110 transmits an RRC: RRC CONNECTION SETUP message to the wireless terminal 4.

In S103, the wireless terminal 4 transmits an RRC: RRC CONNECTION SETUP COMPLETE message to the eNB 110.

In S104, the UE control unit 114 transmits an RRC: UE CAPABILITY ENQUIRY message in order to acquire capability information of the wireless terminal 4.

In S105, the wireless terminal 4 transmits an RRC: UE CAPABILITY INFORMATION message in which capability information of the wireless terminal 4 is stored.

Herein, for instance, the capability information may include featureGroupIndRel10 of 32-bit length. Setting 0 or 1 to a bit included in featureGroupIndRel10 makes it possible to notify the eNB 110 of the presence or absence of a support of a function associated with a set bit. A scheduling policy set in the wireless terminal 4 (UE) is notified to the eNB 110 with use of 2 bits out of a bit string within the featureGroupIndRel10, for instance.

As described above, the scheduling policy is notified, based on a combination of a first bit and a second bit. Thus, it is possible to notify a scheduling policy with less information amount.

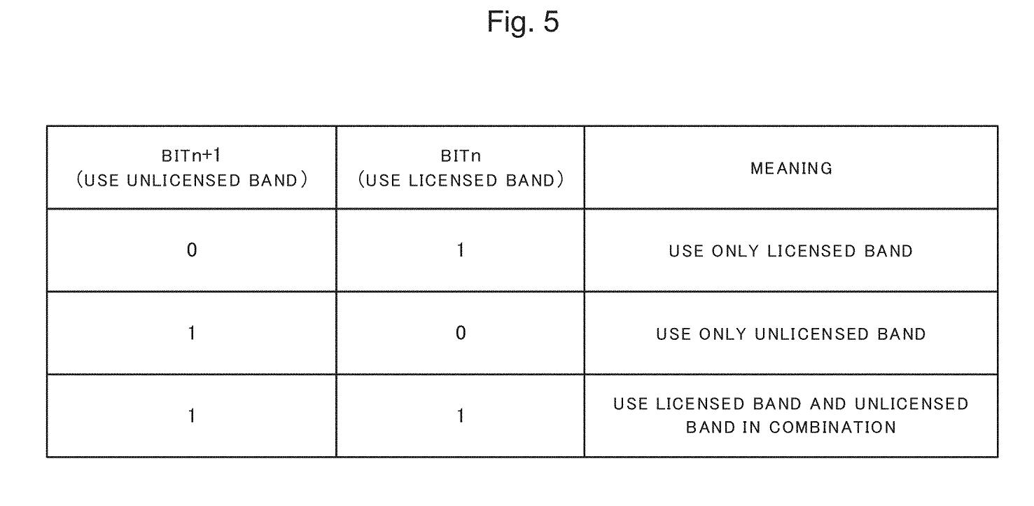

FIG. 5 illustrates another example of a scheduling policy in the first exemplary example embodiment. FIG. 5 illustrates an example of 2 bits in a bit string within featureGroupIndRel10.

Note that the 2 bits may be stored in advance in an SIM card. Note that the 2 bits may be freely set depending on information (or a signal) input to a user interface (not illustrated) of the wireless terminal 4.

With use of the 2 bits, it is possible to notify the eNB 110 of a scheduling policy desired by a user of the wireless terminal 4 in a case where an unlicensed band is usable.

When the UE control unit 114 receives an RRC: UE CAPABILITY INFORMATION message, the UE control unit 114 acquires capability information of the UE stored in the message. Then, the acquired result is stored in the scheduling policy storage unit 115 together with a UE identifier for identifying the UE.

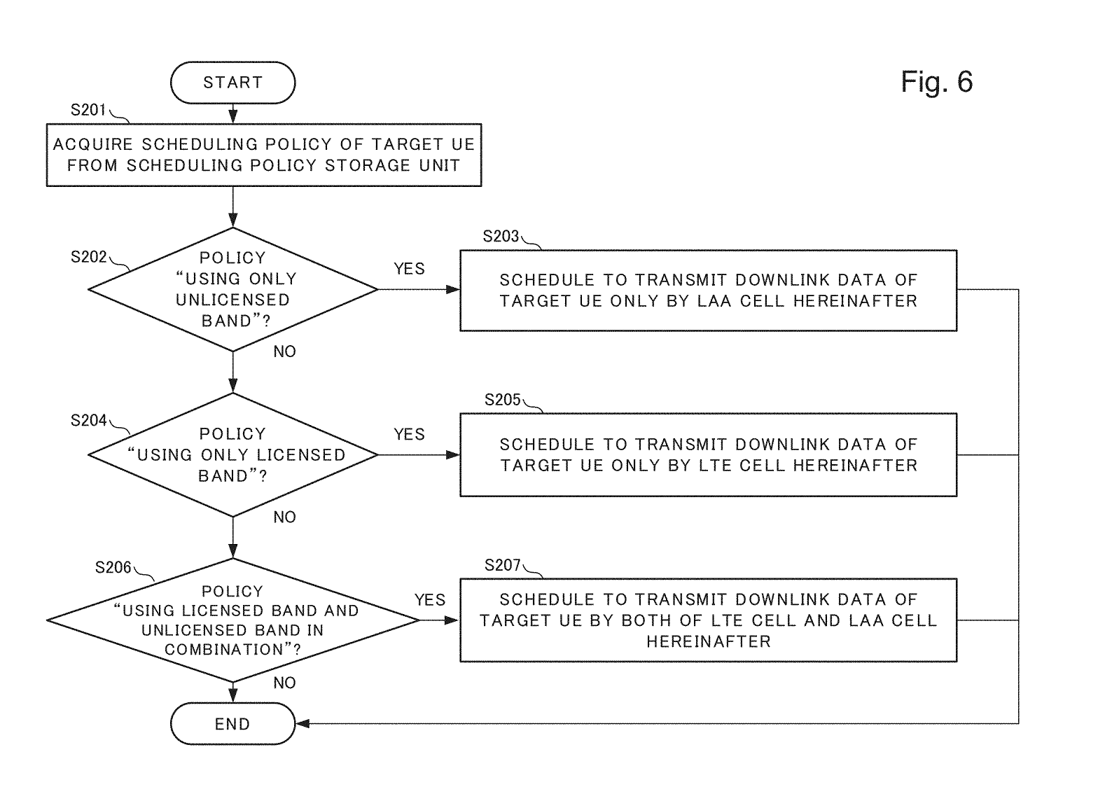

FIG. 6 illustrates an operation in the first exemplary example embodiment.

FIG. 6 illustrates an operation of the scheduling unit 117 in a case where the UE control unit 114 determines that a service is performed with respect to a UE with use of both of the eNB 110 and the LAA base station 140, and the determination result is notified to the scheduling unit 117.

In S201, the scheduling unit 117 receives, from the UE control unit 114, a notification that a service is performed with respect to the wireless terminal 4 with use of both of the eNB 110 and the LAA base station 140. The scheduling unit 117 acquires a scheduling policy of the UE from the scheduling policy storage unit 115 with use of a received UE identifier.

In S202, it is determined whether or not the scheduling policy is “using only an unlicensed band”.

In S203 (in a case of Yes in S202), the scheduling unit 117 performs scheduling of transmitting downlink data to the UE by using only an unlicensed band hereinafter. The scheduling unit 117 performs scheduling of transmitting downlink data only to the LAA communication unit 112.

In S204 (in a case of No in S202), it is determined whether or not the scheduling policy is “using only a licensed band”.

S205 (a case of Yes in S204) indicates that the scheduling policy is “using only a licensed band”. In S205, the scheduling unit 117 performs scheduling of transmitting downlink data to the UE by using only a licensed band. The scheduling unit 117 performs scheduling of transmitting downlink data only to the LTE communication unit 111.

In S206 (in a case of No in S204), it is determined whether or not the scheduling policy is “using a licensed band and an unlicensed band in combination”.

S207 (a case of Yes in S206) indicates that the scheduling policy is “using a licensed band and an unlicensed band in combination”. In S207, the scheduling unit 117 performs scheduling of transmitting downlink data to the UE by using a licensed band and an unlicensed band in combination hereinafter. The scheduling unit 117 performs scheduling of transmitting downlink data to the LTE communication unit 111 and to the LAA communication unit 112.

As described above, an eNB acquires a scheduling policy set in capability of a UE in a case where an unlicensed band is usable when the UE is attached to the eNB, and the eNB stores the acquired value in a scheduling policy storage unit. When the UE is brought to a state that an unlicensed band is also usable, the stored scheduling policy is extracted, and downlink data transmission is scheduled according to the content of the extracted scheduling policy.

According to the example embodiment, it is possible to provide a novel configuration in which wireless resources relating to an unlicensed band and a licensed band are allocated. For instance, in a case where an unlicensed band is usable, it is possible to cause an eNB to transmit downlink data according to preference of the user.

### 2. Second Exemplary Example Embodiment

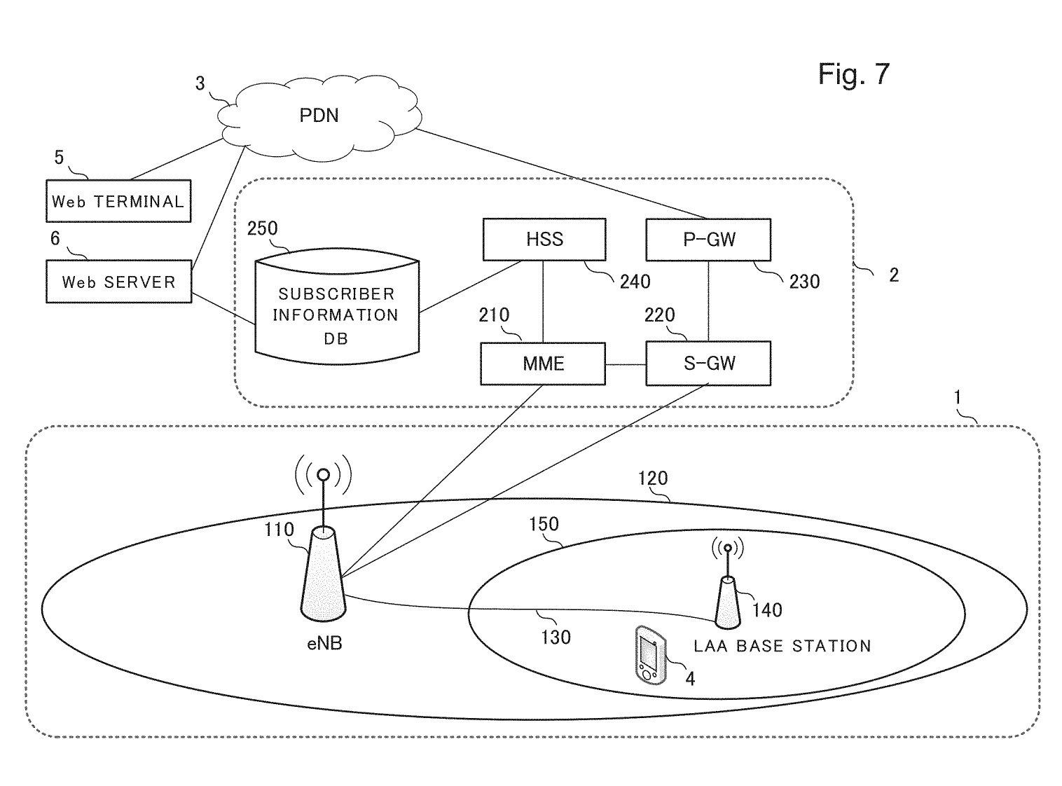

FIG. 7 illustrates a mobile communication system in the second exemplary example embodiment.

The mobile communication system in FIG. 7 is different from that in FIG. 1 in that a subscriber information DB 250, a Web terminal 5, a Web server 6, and an HSS 240 are included. The second exemplary example embodiment is the same as the first exemplary example embodiment in a configuration other than the above, and therefore, description on the other configuration and on an operation thereof is omitted.

The subscriber information DB 250 is configured to store authentication information of a subscriber, service approval information, and a scheduling policy when an unlicensed band is usable.

The HSS 240 performs authentication of a UE (wireless terminal 4) and service approval in response to an enquiry from an MME 210 while referring to the subscriber information DB 250.

The Web terminal 5 is a terminal that accesses the Web server 6. For instance, a user operates the Web terminal 5, and information generated in response to the operation is transmitted to the Web server 6. Thus, a scheduling policy when an unlicensed band is usable is changed.

The Web server 6 is configured to receive a change of a scheduling policy from the Web terminal 5. When the Web server 6 receives a UE identifier and a scheduling policy from the Web terminal 5, the Web server 6 registers the received content in the subscriber information DB 250. Herein, as an example of a UE identifier, an International Mobile Subscriber Identity (IMSI) or an International Mobile Equipment Identity (IMEI) may be used, for instance.

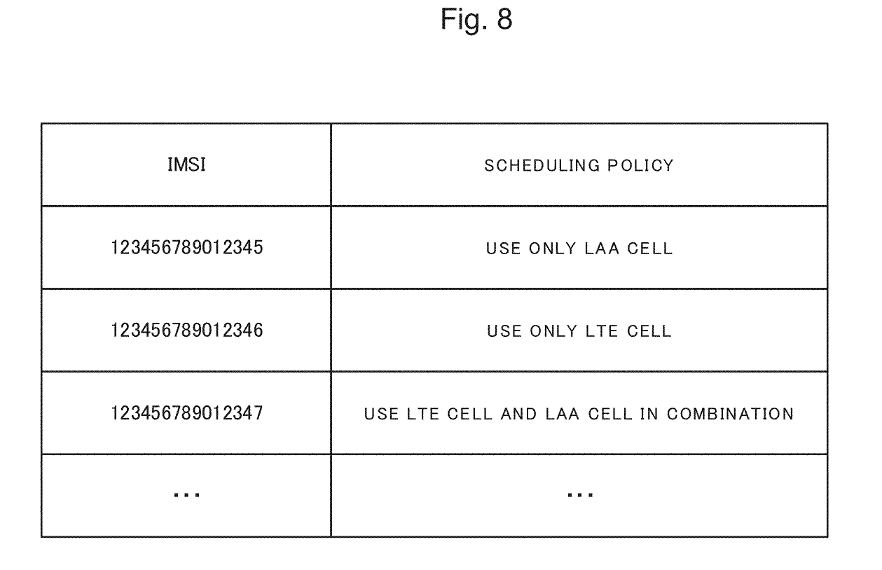

FIG. 8 illustrates an example of a content of the subscriber information DB 250. An IMSI and a scheduling policy are stored in association with each other.

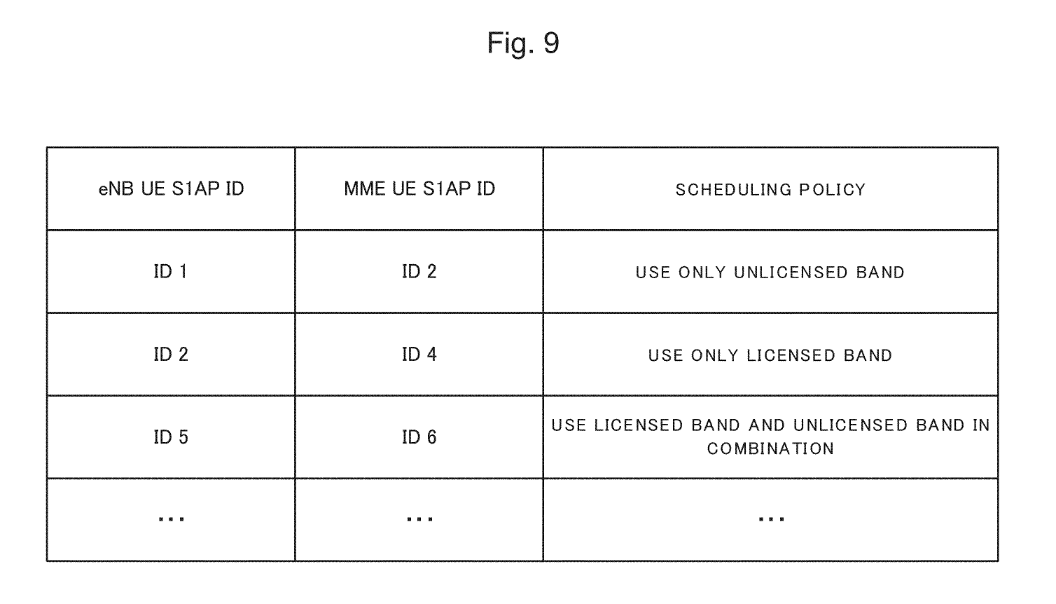

FIG. 9 illustrates an example of a table of a scheduling policy storage unit 115. The configuration of an eNB 110 in the example embodiment is the same as in FIG. 2. Note that a scheduling policy is stored together with an eNB UE S1 Application Protocol (AP) ID and an MME UE S1 Application Protocol (AP) ID in a table of the scheduling policy storage unit 115.

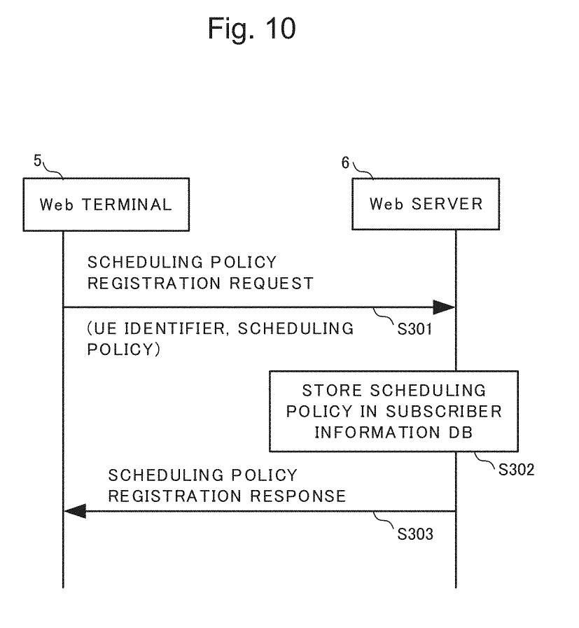

FIG. 10 illustrates an operation in the second exemplary example embodiment.

In S301, the Web terminal 5 transmits, to the Web server 6, a scheduling policy registration request in which a UE identifier and a scheduling policy are stored.

In S302, the Web server 6 registers a received UE identifier and a received scheduling policy in the subscriber information DB 250.

In S303, the Web server 6 transmits a scheduling policy registration response to the Web terminal 5.

As another method, a Web terminal may not directly transmit a UE identifier to the Web server 6. For instance, the Web terminal 5 may transmit information (e.g. a telephone number, etc.) for uniquely specifying UE identifier information to the Web server 6, and the Web server 6 may specify the UE identifier with use of the information and store the specified UE identifier in a scheduling policy storage means.

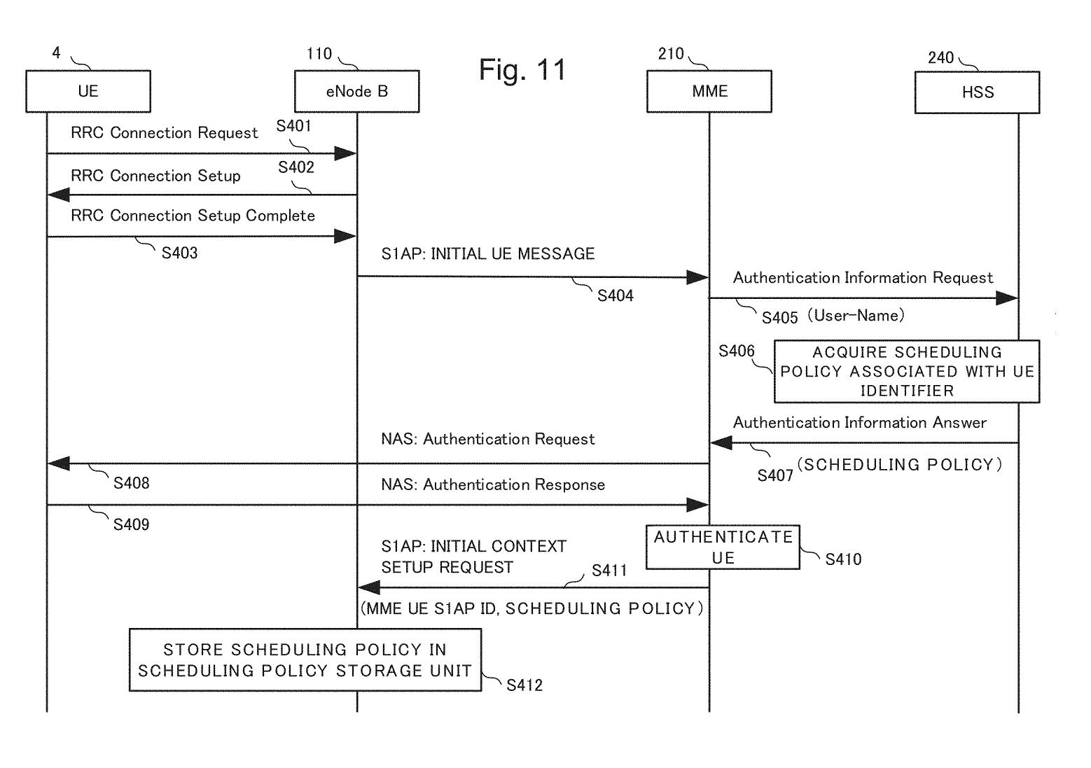

FIG. 11 illustrates an operation in a case where a UE is attached to the eNB 110.

In S401, the wireless terminal 4 (UE) transmits an RRC Connection Request message to the eNB 110.

In S402, the eNB 110 transmits an RRC Connection Setup message to the wireless terminal 4.

In S403, the wireless terminal 4 transmits an RRC Connection Setup Complete message to the eNB 110.

In S404, the eNB 110 transmits an S1AP: Initial UE Message to the MME 210 in response to receiving an RRC Connection Setup Complete message. In this case, the eNB 110 stores an Attach Request stored in the received RRC Connection Setup Complete Message into the Initial UE Message for transfer.

In S405, the MME 210 transmits, to the HSS 240, an Authentication Information Request message being a message requesting authentication information in response to receiving the Attach Request stored in the Initial UE Message. Information corresponding to an IMSI of a UE is stored in a User-Name AVP (Attribute Value Pair) in the Authentication Information Request message.

In S406, the HSS 240 extracts the IMSI of the UE from the User-Name AVP in the Authentication Information Request message. The HSS 240 acquires a scheduling policy associated with the UE identifier from the subscriber information DB 250 with use of the IMSI.

In S407, the HSS 240 returns the acquired scheduling policy while carrying the acquired scheduling policy on an Authentication Information Answer message.

In S408 and S409, when the MME 210 receives the Authentication Information Answer message, after extracting scheduling policy information, the MME 210 exchanges an NAS message for authenticating a UE with the UE. An NAS: Authentication Request message (S408) is transmitted from the MME 210 to the eNB 110. In response to the transmission, an NAS: Authentication Response message is transmitted from the wireless terminal 4 to the MME 210.

In S410, as a result of message exchange, the MME 210 authenticates the UE. When authentication is successful, S411 is performed.

In S411, the MME 210 transmits, to the eNB 110, an MME UE S1AP ID, and a scheduling policy extracted from the Authentication Information Answer message while carrying the MME UE S1AP ID and the scheduling policy on an S1AP: INITIAL CONTEXT SETUP REQUEST message.

In S412, the eNB 110 that receives the S1AP: INITIAL CONTEXT SETUP REQUEST message stores, in the scheduling policy storage unit 115, the scheduling policy together with an eNB UE S1AP ID and the MME UE S1AP ID for identifying the UE. An image of a stored status is the same as in FIG. 9, for instance.

An operation of the scheduling unit 117 in the example embodiment is the same as in the first exemplary example embodiment.

### 3. Third Exemplary Example Embodiment

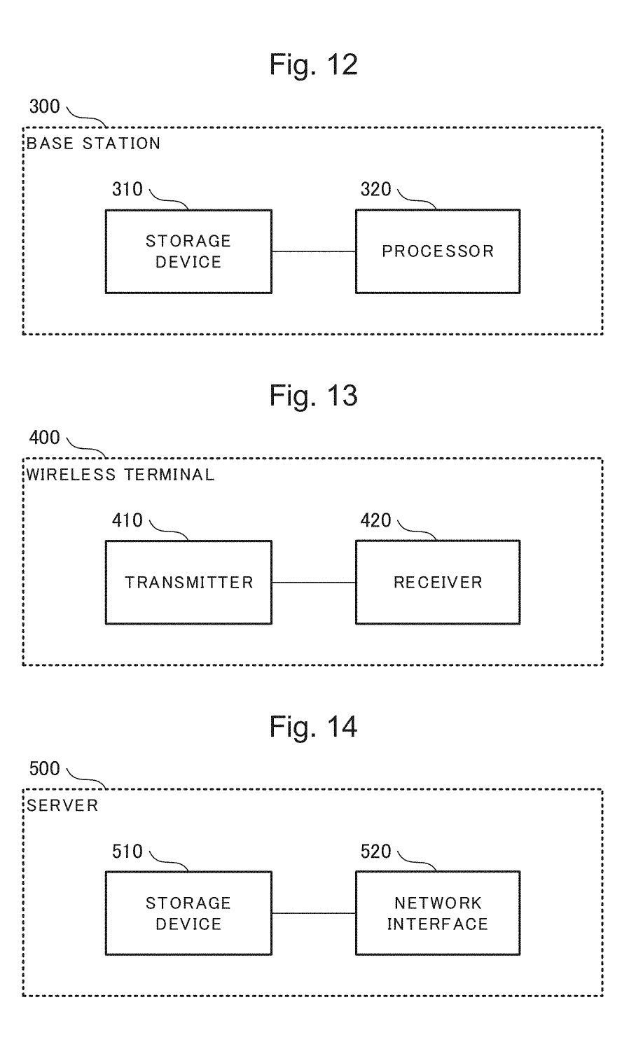

FIG. 12 illustrates a base station in a third exemplary example embodiment.

A base station 300 is configured to perform wireless communication with a wireless terminal. The base station 300 includes a storage device 310 and a processor 320.

The storage device 310 is configured to store a scheduling policy associated with an identifier of a wireless terminal, and indicating that at least one of a first frequency band and a second frequency band is used for wireless communication.

The processor 320 is configured to determine a first scheduling policy associated with a first identifier of a first wireless terminal, based on a storage device when implementation of carrier aggregation relating to the first frequency band and the second frequency band is determined, and to allocate wireless resources to the first wireless terminal, based on the first scheduling policy.

FIG. 13 illustrates a wireless terminal in the third exemplary example embodiment.

A wireless terminal 400 is configured to perform wireless communication with a base station. The wireless terminal 400 includes a transmitter 410 and a receiver 420.

The transmitter 410 is configured to transmit, to a base station, a message including a scheduling policy associated with an identifier of a wireless terminal, and indicating that at least one of a first frequency band and a second frequency band is used for wireless communication.

The receiver 420 is configured to receive allocation of wireless resources to be performed based on a scheduling policy after implementation of carrier aggregation relating to the first frequency band and the second frequency band is determined.

FIG. 14 illustrates a server in the third exemplary example embodiment.

A server 500 includes a storage device 510 and a network interface 520.

The storage device 510 is configured to store a scheduling policy associated with an identifier of a wireless terminal, and indicating that at least one of a first frequency band and a second frequency band is used for wireless communication between the wireless terminal and a base station.

The network interface 520 is configured to transmit a scheduling policy to a core network device included in a core network when an identifier of a wireless terminal is received from the core network device.

Wireless resources are allocated to a wireless terminal based on a scheduling policy after implementation of carrier aggregation relating to the first frequency band and the second frequency band is determined.

Note that herein, the Web server 6 and the subscriber information DB 250 altogether may be referred to as a server.

According to the example embodiment, it is possible to provide a novel configuration in which wireless resources relating to different frequency bands are allocated.

### 4. Modification Examples of Example Embodiments

### First Modification Example

The aforementioned example embodiments not only relate to scheduling of downlink data but also relate to scheduling of uplink data. In other words, a scheduling unit 117 may perform scheduling not only in a downlink direction but also in an uplink direction.

A UE requests an eNB for scheduling of data transmission in an uplink direction (SR: Scheduling Request). In response to a scheduling request from the UE, the eNB allocates resources to the UE in an uplink direction.

Therefore, in a case where a scheduling policy is stored in UE Capability, it is possible to implement scheduling by causing the UE to perform a scheduling request to the eNB according to the policy.

Further, in a case where a scheduling policy is set on the side of a network with use of a Web terminal/a Web server, it is possible to notify the scheduling policy set in the network by adding an IE to a predetermined message or to a predetermined signal. Moreover, it is also possible to notify the UE by adding a new message. Additionally, it is possible to implement scheduling by causing a UE to perform a scheduling request to the eNB according to a notified policy.

### Second Modification Example

In the foregoing, an LAA system is exemplified as a communication means of an unlicensed band. Note that the aforementioned example embodiments are not limited to an LAA system but are applicable to another system. For instance, it is possible to apply the example embodiments even in a case where LWA (LTE-WiFi Link Aggregation) is used as another means in which a licensed band and an unlicensed band are used in combination.

### Third Modification Example

In the foregoing, there is described a case where an ideal backhaul (a relatively high-speed (low latency) line such as an optical fiber) is used as a backhaul of LAA, and carrier aggregation is implemented between LTE and LAA. The aforementioned example embodiments are also applicable to a case where a non-ideal backhaul is used, and an LTE cell and an LAA cell are connected by Dual Connectivity. It is possible to apply Dual Connectivity to a Split Bearer system. Note that it is possible to perform Dual Connectivity by an LTE cell and an LAA cell as described above. It is also possible to perform Dual Connectivity by cells which use a licensed band. Further, for instance, it is also possible to perform Dual Connectivity in different cells described in fifth and sixth modification examples to be described later.

### Fourth Modification Example

In the foregoing, a scheduling policy is a policy such that only one of bands is used, or both of bands are used. The example embodiments, however, are not necessarily limited to the above.

For instance, it is possible to use a policy such that only an unlicensed band is used as far as the bit rate on a side of the unlicensed band is equal to or higher than a certain threshold value, or a licensed band is also used in combination or only a licensed band is used when the bit rate is lower than the threshold value.

Further, for instance, it is possible to use a policy such that a licensed band and an unlicensed band are used in combination as far as the packet communication fee for this month is lower than xx yen, or only an unlicensed band is used when the packet communication fee for this month is equal to or higher than xx yen.

### Fifth Modification Example

In the foregoing, a scheduling policy between two cells is described by classification as to whether a band is a licensed band or an unlicensed band. Note that the exemplary example embodiments are not limited to a case of carrier aggregation of two cells, but are also applicable to a case of carrier aggregation of three or more cells.

### Sixth Modification Example

In the foregoing, a scheduling policy is determined by classification as to whether a band is a licensed band or an unlicensed band. The exemplary example embodiments, however, are not necessarily limited to the aforementioned classification. It is possible to apply a policy by another cell feature. The feature may be propagation characteristics, or some feature that generates a difference in usage charge, for instance.

For instance, in a case where a cell using a high frequency band, and a cell using a low frequency band are used in combination, it is possible to select a frequency to be used according to a policy. Further, in a case where a 5G (generation) cell relating to wireless mobile communication of the fifth generation, and a 4G cell are used in combination, it is possible to select a cell to be used according to a policy.

### Seventh Modification Example

In the foregoing, scheduling is performed according to a scheduling policy relating to different frequency bands. For instance, it is possible to use different cells, in place of different frequency bands. Herein, different cells are distinguishable by different frequencies in a same frequency band. Further, for instance, different cells may be distinguishable by different codes (e.g. spreading codes) although a same frequency is used.

### 5. Related Art

The inventor has made the following study regarding an unlicensed band.

First of all, regarding an unlicensed band, a frequency band to be used is shared by a plurality of devices. Further, it is not possible to guarantee QoS for communication using this band. In view of the above, for instance, a communication service of public WiFi is provided free of charge or at a low price, as compared with a communication service charge of LTE or the like which uses a licensed band. Therefore, in a case where an operator provides an LAA service, it is conceived that communication using an unlicensed band is provided free of charge or at a low price.

When there is a charge difference between a case where a licensed band is used and a case where an unlicensed band is used as described above, a user may be allowed to select which one of the frequency bands is used for communication depending on circumstances. For instance, in a case where a user wishes to perform communication at a low price with a communication quality like WiFi anyway, the user is allowed to use only LAA. Further, in a case where a quality as high as the quality of voice communication is important, a user is allowed to use only LTE which uses a licensed band. Further, in a case where a user wishes to secure high throughput anyway, the user is allowed to use both of LTE and LAA. As described above, a configuration such that a user is allowed to optionally select a frequency band depending on circumstances is expected.

According to the example embodiments, for instance, it is possible to set how much amount of traffic is distributed to a primary cell or to a secondary cell.

This setting may be performed based on information requested by a user using a wireless terminal, for instance. For instance, in a case where a user wishes to perform communication by using only an LAA cell in which an unlicensed band is used in an environment where carrier aggregation is implemented by using an LAA cell as a secondary cell, it is possible to distribute traffic only to the unlicensed band. In the carrier aggregation technique described in NPL 1, designation such that traffic is distributed only to an unlicensed band is not performed taking into account a request in a wireless terminal.

As described above, in the exemplary example embodiments, a novel configuration relating to scheduling is provided. This makes it possible to distribute traffic according to a user's request in an environment where a plurality of communication means are usable, for instance.

### 6. Other Exemplary Example Embodiments

In the foregoing, an identifier of a UE (a wireless terminal) may be stored in a Subscriber Identity Module (SIM) card, or may be stored in a storage device (a memory) provided in the UE. Further, a scheduling policy may be stored in an SIM card, or may be stored in a storage device (a memory) provided in a UE. It is possible to configure a UE in such a manner that a scheduling policy associated with an identifier of the UE is transmitted from at least one of an SIM card and a storage device when a message is sent to an eNB.

In the foregoing, a process to be performed by each of the constituent elements provided in a communication system may be performed by each logic circuit manufactured depending on a purpose.

Further, a computer program (hereinafter, referred to as a program) in which processing contents are described as a sequence may be recorded in a recording medium readable by each of the elements constituting a communication system, and a program recorded in the recording medium may be read in each of the constituent elements of a wireless communication system for execution.

A program recorded in the recording medium is read by a Central Processing Unit (CPU) provided in each of the constituent elements of a communication system, and a same process as described above is performed by control of the CPU. Herein, the CPU is a unit that operates as a computer which executes a program read from a recording medium having the program recorded therein.

In the aforementioned example, a program is stored with use of a non-transitory computer readable medium of various types, and is suppliable to a computer. The non-transitory computer readable medium includes a tangible storage medium of various types. Examples of the non-transitory computer readable medium include a magnetic recording medium (e.g. a flexible disk, a magnetic tape, and a hard disk drive), a magneto-optical recording medium (e.g. a magneto-optical disk), a CD (Compact Disc)-ROM (Read Only Memory), a CD-R (Compact Disc Recordable), a CD-R/W (Compact Disc Rewritable), a Digital Versatile Disk (DVD, a registered trademark), and a semiconductor memory (e.g. a mask ROM, a PROM (Programmable ROM), an EPROM (Erasable PROM), a flash ROM, and an RAM (Random Access Memory)). Further, a program may be supplied to a computer by a transitory computer readable medium of various types. Examples of the transitory computer readable medium include an electrical signal, an optical signal, and an electromagnetic wave. The transitory computer readable medium can supply a program to a computer via a wired communication channel such as an electric wire and an optical fiber, or via a wireless communication channel.

It is needless to say that the invention is not limited only to the above-described embodiments, and various changes may be made therein without departing from the gist of the present invention described above. It is not necessary to perform, in a specific order, at least either one of the functions, the steps, and the operations according to each example embodiment described herein. Further, the components in the present invention may be described or claimed in the singular form, but may be understood as described in the plural form unless it is explicitly mentioned to limit the component to the singular form.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### Supplementary Notes

A part or all of the exemplary example embodiments may be described as the following Supplementary notes. However, each of the following Supplementary notes is merely a simple example of the present invention, and the present invention is not limited to the examples.

### Supplementary Note 1

A base station configured to perform wireless communication with a wireless terminal, the base station comprising:

a storage device configured to store a scheduling policy associated with an identifier of the wireless terminal, and indicating that at least one of a first frequency band and a second frequency band is used for the wireless communication; and

a processor configured to determine a first scheduling policy associated with a first identifier of a first wireless terminal, based on the storage device when implementation of carrier aggregation relating to the first frequency band and the second frequency band is determined, and to allocate wireless resources to the first wireless terminal, based on the first scheduling policy.

### Supplementary Note 2

The base station according to Supplementary note 1, further comprising:

a communicator configured to receive the scheduling policy associated with the identifier of the wireless terminal from the wireless terminal,

wherein the storage device stores the scheduling policy received by the communicator.

### Supplementary Note 3

The base station according to Supplementary note 1 or 2,

wherein the scheduling policy is included in a UE Capability Information message to be transmitted by the wireless terminal. (Supplementary note 4)

The base station according to Supplementary note 3,

wherein the UE Capability Information message includes
a first bit indicating whether or not the first frequency band is used, and
a second bit indicating whether or not the second frequency band is used, and

wherein the scheduling policy is notified, based on combination of the first bit and the second bit.

### Supplementary Note 5

The base station according to Supplementary note 2,

wherein the communicator receives the scheduling policy when the wireless terminal transmits an attach request message to the base station.

### Supplementary Note 6

The base station according to Supplementary note 1, further comprising:

a network interface configured to receive the scheduling policy from a core network device.

### Supplementary Note 7

The base station according to Supplementary note 6,

wherein the scheduling policy to be received from the core network device is associated with an identifier for identifying the wireless terminal included in an attach request message to be transmitted from the wireless terminal to the base station.

### Supplementary Note 8

A wireless terminal configured to perform wireless communication with a base station, the wireless terminal comprising:

a transmitter configured to transmit, to the base station, a message including a scheduling policy associated with an identifier of a wireless terminal, and indicating that at least one of a first frequency band and a second frequency band is used for the wireless communication; and

a receiver configured to receive allocation of wireless resources to be performed based on the scheduling policy after implementation of carrier aggregation relating to the first frequency band and the second frequency band is determined.

### Supplementary Note 9

The wireless terminal according to Supplementary note 8,

wherein the scheduling policy is included in a UE Capability Information message to be transmitted by the wireless terminal.

### Supplementary Note 10

The wireless terminal according to Supplementary note 9,

wherein the message includes
a first bit indicating whether or not the first frequency band is used, and
a second bit indicating whether or not the second frequency band is used, and

wherein the scheduling policy is notified, based on combination of the first bit and the second bit.

### Supplementary Note 11

The wireless terminal according to Supplementary note 8,

wherein the transmitter transmits the scheduling policy when the wireless terminal transmits an attach request message to the base station.

### Supplementary Note 12

A server comprising:

a storage device configured to store a scheduling policy associated with an identifier of a wireless terminal, and indicating that at least one of a first frequency band and a second frequency band is used for wireless communication between the wireless terminal and a base station; and

a network interface configured to transmit the scheduling policy to a core network device included in a core network when the network interface receives the identifier of the wireless terminal from the core network device,

wherein wireless resources are allocated to the wireless terminal based on the scheduling policy after implementation of carrier aggregation relating to the first frequency band and the second frequency band is determined.

### Supplementary Note 13

The server according to Supplementary note 12,

wherein the network interface transmits the scheduling policy to the core network device when the wireless terminal transmits an attach request message to the base station.

### Supplementary Note 14

The server according to Supplementary note 13,

wherein a scheduling policy to be transmitted to the core network device is associated with an identifier for identifying the wireless terminal included in an attach request message to be transmitted from the wireless terminal to the base station.

### Supplementary Note 15

A control method of a base station configured to perform wireless communication with a wireless terminal, the control method comprising:

storing a scheduling policy associated with an identifier of the wireless terminal, and indicating that at least one of a first frequency band and a second frequency band is used for the wireless communication;

determining a first scheduling policy associated with a first identifier of a first wireless terminal out of the stored scheduling policy when implementation of carrier aggregation relating to the first frequency band and the second frequency band is determined; and

allocating wireless resources to the first wireless terminal, based on the first scheduling policy.

### Supplementary Note 16

The control method of a base station according to Supplementary note 15,

wherein the scheduling policy to be stored is received from the wireless terminal, and

the scheduling policy is associated with the identifier of a wireless terminal that transmits the scheduling policy.

### Supplementary Note 17

The control method of a base station according to Supplementary note 15 or 16,

wherein the scheduling policy is included in a UE Capability Information message to be transmitted by the wireless terminal.

### Supplementary Note 18

The control method of a base station according to Supplementary note 17,

wherein the UE Capability Information message includes
a first bit indicating whether or not the first frequency band is used, and
a second bit indicating whether or not the second frequency band is used, and

wherein the scheduling policy is notified, based on combination of the first bit and the second bit.

### Supplementary Note 19

The control method of a base station according to Supplementary note 16,

receiving the scheduling policy when the wireless terminal transmits an attach request message to the base station.

### Supplementary Note 20

The control method of a base station according to Supplementary note 15,

wherein the scheduling policy is received from a core network device.

### Supplementary Note 21

The control method of a base station according to Supplementary note 20,

wherein the scheduling policy to be received from the core network device is associated with an identifier for identifying the wireless terminal included in an attach request message to be transmitted from the wireless terminal to the base station.

### Supplementary Note 22

A control method of a wireless terminal configured to perform wireless communication with a base station comprising:

transmitting, to the base station, a message including a scheduling policy associated with an identifier of a wireless terminal, and indicating that at least one of a first frequency band and a second frequency band is used for the wireless communication; and

receiving allocation of wireless resources to be performed based on the scheduling policy after implementation of carrier aggregation relating to the first frequency band and the second frequency band is determined.

### Supplementary Note 23

The control method of a wireless terminal according to Supplementary note 22,

wherein the scheduling policy is included in a UE Capability Information message to be transmitted by the wireless terminal.

### Supplementary Note 24

The control method of a wireless terminal according to Supplementary note 23,

wherein the message includes
a first bit indicating whether or not the first frequency band is used, and
a second bit indicating whether or not the second frequency band is used, and

wherein the scheduling policy is notified, based on combination of the first bit and the second bit.

### Supplementary Note 25

The control method of a wireless terminal according to at least one of Supplementary notes 22 to 24,

wherein the scheduling policy is transmitted when the wireless terminal transmits an attach request message to the base station.

### Supplementary Note 26

A control method of a server comprising:

storing a scheduling policy associated with an identifier of a wireless terminal, and indicating that at least one of a first frequency band and a second frequency band is used for wireless communication between the wireless terminal and a base station;

transmitting the scheduling policy to a core network device included in a core network when the identifier of the wireless terminal is received from the core network device; and

allocating wireless resources to the wireless terminal based on the scheduling policy after implementation of carrier aggregation relating to the first frequency band and the second frequency band is determined.

### Supplementary Note 27

The control method of a server according to Supplementary note 26,

wherein the scheduling policy is transmitted to the core network device when the wireless terminal transmits an attach request message to the base station.

### Supplementary Note 28

The control method of a server according to Supplementary note 27,

wherein a scheduling policy to be transmitted to the core network device is associated with an identifier for identifying the wireless terminal included in an attach request message to be transmitted from the wireless terminal to the base station.

### Supplementary Note 29

A program that causes a computer to execute:

storing a scheduling policy associated with an identifier of a wireless terminal, and indicating that at least one of a first frequency band and a second frequency band is used for wireless communication between the wireless terminal and a base station;

determining a first scheduling policy associated with a first identifier of a first wireless terminal, based on the storage device when implementation of carrier aggregation relating to the first frequency band and the second frequency band is determined; and

allocating wireless resources to the first wireless terminal, based on the first scheduling policy.

### Supplementary Note 30

The program according to Supplementary note 29,

wherein the scheduling policy to be stored is received from the wireless terminal, and

the scheduling policy is associated with the identifier of a wireless terminal that transmits the scheduling policy.

### Supplementary Note 31

The program according to Supplementary note 29 or 30,

wherein the scheduling policy is included in a UE Capability Information message to be transmitted by the wireless terminal.

### Supplementary Note 32

The program according to Supplementary note 31,

wherein the UE Capability Information message includes
a first bit indicating whether or not the first frequency band is used, and
a second bit indicating whether or not the second frequency band is used, and

wherein the scheduling policy is notified, based on combination of the first bit and the second bit.

### Supplementary Note 33

The program according to Supplementary note 30,

receiving the scheduling policy when the wireless terminal transmits an attach request message to the base station.

### Supplementary Note 34

A communication system comprising:

a wireless terminal; and

a base station,

wherein the base station is configured to perform wireless communication with a wireless terminal,

wherein the base station is configured to store a scheduling policy associated with an identifier of the wireless terminal, and indicating that at least one of a first frequency band and a second frequency band is used for the wireless communication,

wherein the base station is configured to determine a first scheduling policy associated with a first identifier of a first wireless terminal, based on the storage device when implementation of carrier aggregation relating to the first frequency band and the second frequency band is determined, and

wherein the base station is configured to allocate wireless resources to the first wireless terminal, based on the first scheduling policy.

### Supplementary Note 35

The communication system according to Supplementary note 34,

wherein the wireless terminal transmits the scheduling policy associated with the identifier of the wireless terminal, and

wherein the base station stores the scheduling policy received from the wireless terminal.

### Supplementary Note 36

The communication system according to Supplementary note 34 or 35,

wherein the scheduling policy is included in a UE Capability Information message to be transmitted by the wireless terminal.

### Supplementary Note 37

The communication system according to Supplementary note 36,

wherein the UE Capability Information message includes
a first bit indicating whether or not the first frequency band is used, and
a second bit indicating whether or not the second frequency band is used, and

wherein the scheduling policy is notified, based on combination of the first bit and the second bit.

### Supplementary Note 38

The communication system according to Supplementary note 35,

wherein the base station receives the scheduling policy when the wireless terminal transmits an attach request message to the base station.

### Supplementary Note 39

The communication system according to Supplementary note 34,

wherein the base station receives the scheduling policy from a core network device.

### Supplementary Note 40

The communication system according to Supplementary note 39,

wherein the scheduling policy to be received from the core network device is associated with an identifier for identifying the wireless terminal included in an attach request message to be transmitted from the wireless terminal to the base station.

### REFERENCE SIGNS LIST

1 E-UTRAN
2 EPC
3 PDN
4 Wireless terminal
5 Web terminal
6 Web server
110 eNB
111 LTE communication unit
112 LAA communication unit
113 EPC communication unit
114 UE control unit
115 Scheduling policy storage unit
116 Received data storage unit
117 Scheduling unit
120 LTE cell
130 Inter-base station interface
140 LAA base station
150 LAA cell
210 MME
220 S-GW
230 P-GW
240 HSS
250 Subscriber information DB
300 Base station
310 Storage device
320 Processor
400 Wireless terminal
410 Transmitter
420 Receiver
500 Server
510 Storage device
520 Network interface

What is claimed is:

1. A base station configured to perform wireless communication with a wireless terminal, the base station comprising:
a storage device configured to store a scheduling policy associated with an identifier of the wireless terminal, and indicating that at least one of a first frequency band and a second frequency band is used for the wireless communication; and
a processor configured to determine a first scheduling policy associated with a first identifier of a first wireless terminal, based on the storage device when implementation of carrier aggregation relating to the first frequency band and the second frequency band is determined, and to allocate wireless resources to the first wireless terminal, based on the first scheduling policy.

2. The base station according to claim 1, further comprising:
a communicator configured to receive the scheduling policy associated with the identifier of the wireless terminal from the wireless terminal,
wherein the storage device stores the scheduling policy received by the communicator.

3. The base station according to claim 1,
wherein the scheduling policy is included in a UE Capability Information message to be transmitted by the wireless terminal.

4. The base station according to claim 3,
wherein the UE Capability Information message includes
a first bit indicating whether or not the first frequency band is used, and
a second bit indicating whether or not the second frequency band is used, and
wherein the scheduling policy is notified, based on combination of the first bit and the second bit.

5. The base station according to claim 2,
wherein the communicator receives the scheduling policy when the wireless terminal transmits an attach request message to the base station.

6. The base station according to claim 1, further comprising:
a network interface configured to receive the scheduling policy from a core network device.

7. The base station according to claim 6,
wherein the scheduling policy to be received from the core network device is associated with an identifier for identifying the wireless terminal included in an attach request message to be transmitted from the wireless terminal to the base station.

8. A wireless terminal configured to perform wireless communication with a base station, the wireless terminal comprising:
a transmitter configured to transmit, to the base station, a message including a scheduling policy associated with an identifier of a wireless terminal, and indicating that at least one of a first frequency band and a second frequency band is used for the wireless communication; and
a receiver configured to receive allocation of wireless resources to be performed based on the scheduling policy after implementation of carrier aggregation relating to the first frequency band and the second frequency band is determined.

9. A control method of a base station configured to perform wireless communication with a wireless terminal, the control method comprising:
storing a scheduling policy associated with an identifier of the wireless terminal, and indicating that at least one of a first frequency band and a second frequency band is used for the wireless communication;
determining a first scheduling policy associated with a first identifier of a first wireless terminal out of the stored scheduling policy when implementation of carrier aggregation relating to the first frequency band and the second frequency band is determined; and
allocating wireless resources to the first wireless terminal, based on the first scheduling policy.
